(19) United States
(12) Patent Application Publication
(10) Pub. No.: US 2017/0158143 A1
(43) Pub. Date: Jun. 8, 2017

(54) CONSOLE ORGANIZER

(71) Applicants: Kathryn Wimbley, Midwest City, OK (US); Cleveland Wimbley, Midwest City, OK (US)

(72) Inventors: Kathryn Wimbley, Midwest City, OK (US); Cleveland Wimbley, Midwest City, OK (US)

(21) Appl. No.: 14/959,227

(22) Filed: Dec. 4, 2015

(51) Int. Cl. B60R 7/08; B60R 7/04

(52) U.S. Cl. CPC B60R 7/08; B60R 7/04

(57) ABSTRACT

A console organizer that includes: four outer walls, where the four outer walls create an open space; a first divider, where first divider extends between two diagonal corners; a second divider, where the second divider extends between two diagonal corners and intersects with the first divider at a center point of the open space; and four storage sections. Each section preferably includes an outer wall and two inner walls.

### BACKGROUND OF THE INVENTION

Field of Invention

The present invention relates to a console organizer for use for a center console of a motor vehicle.

Description of Related Art

Many motor vehicles include a center console for storage of various types items. Typically, individuals place various items within the console, such as phone chargers, flashlight, extra utensils or various other items that may be used while in the vehicle. Some individuals also place gloves, lip balm, eye drop or other items in their console to use as they travel in their motor vehicle. Many center consoles are just open space and fail to provide any type of organizing dividers or sections to help in organizing the console while using it for storage of items. As a result, it would be advantageous to have some type of device that may be installed or mounted within the center console to provide organizing capabilities.

### SUMMARY OF THE INVENTION

The present invention relates to a console organizer that includes: four outer walls, where the four outer walls create an open space; a first divider, where first divider extends between two diagonal corners; a second divider, where the second divider extends between two diagonal corners and intersects with the first divider at a center point of the open space; and four storage sections. Each section preferably includes an outer wall and two inner walls.

### BRIEF DESCRIPTION OF DRAWINGS

FIG. 1 depicts a front view of a console organizer in accordance with the present invention.

FIG. 2 depicts a top view of a console organizer in accordance with the present invention.

FIG. 3 provides a side view of a divider used with the organizer according to the present invention.

### DETAILED DESCRIPTION

The present invention relates to a console organizer for use in conjunction within a center console for a motor vehicle. Many automobiles or other motor vehicles include a center console that is open and provides open storage space for our various items. The present invention provides an organizer for the console. The present invention divides the console into four sectional compartments to assist the user in organizing items within the center console. The organizer helps the user to locate and store items in an organized manner to avoid items being lost over a period of time.

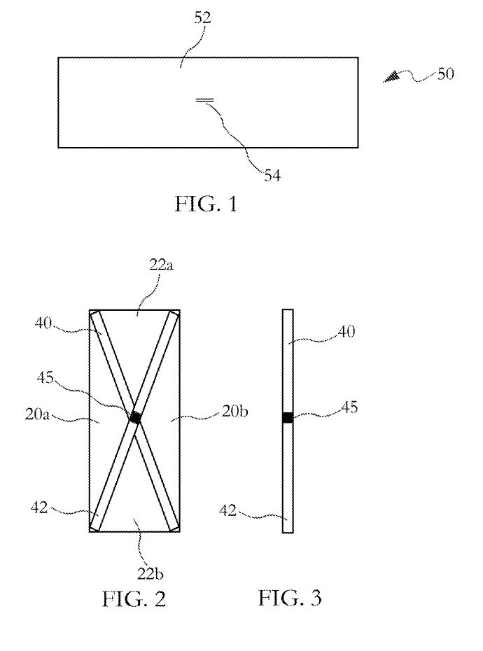

In reference to FIG. 1, a front view of a console organizer 50 is depicted. The console organizer 50 includes a front surface 52 that abuts against the inner surface of the console. Shown at the center of this front surface 52 is a divider attachment 54 showing the location of the divider on the inside of the console organizer 50. A top view of the console organizer is shown in FIG. 2. The console organizer 50 preferably includes four sides with an open space. The console organizer 50 is comprised of a first divider 40 and a second divider 42 that extend diagonally across the center of the console organizer 50. The console organizer 50 has a center connector 45 that connects the first divider 40 to the second divider 42. Dividers 40, 42 extend between two opposing diagonal corners of the console organizer 50. As a result, using the console organizer 50 creates four storage sections, sections 20a, 20b and sections 22a, 22b within the open space within the four walls of the organizer 50. Each section includes an outer wall and two inner walls comprised of the first divider and second divider.

In FIG. 3, a depiction of the side of the dividers 40, 42 intersecting on the interior of the console 50. During use this console organizer 50 is placed within the center console opening to create an organizing device for the use thereof. The console organizer creates sections within the console therefore providing discreet sections within the console for storage of items. The instant invention has been shown and described in what it considers to be the most practical and preferred embodiments. It is recognized, however, that departures may be made there from within the scope of the invention and that obvious modifications will occur to a person skilled in the art.

1. A console organizer comprising:
a) four outer walls, where the four outer walls create an open space;
b) a first divider, where first divider extends between two diagonal corners;
c) a second divider, where the second divider extends between two diagonal corners and intersects with the first divider at a center point of the open space; and
d) four storage sections.

2. The console organizer according to claim 1, where each section includes an outer wall and two inner walls.
